(19) United States
(12) Patent Application Publication
(10) Pub. No.: US 2011/0055814 A1
(43) Pub. Date: Mar. 3, 2011

(54) COMPILER-ASSISTED PROGRAM SOURCE CODE FILTER

(75) Inventors: Robert M. N. Klarer, Toronto (CA); Sean D. Perry, Toronto (CA)

(73) Assignee: INTERNATIONAL BUSINESS MACHINES CORPORATION, Armonk, NY (US)

(21) Appl. No.: 12/859,091

(22) Filed: Aug. 18, 2010

(30) Foreign Application Priority Data
Aug. 28, 2009 (CA) 2675692

(51) Int. Cl. G06F 9/45; G06F 9/44

(52) U.S. Cl. 717/124; 717/136; 717/140

(57) ABSTRACT

A computer implemented method, apparatus, and computer program product for filtering source code are described. A code filtering compiler identifies an entry for a named entity in a symbol table. When a flag for the named entity in the symbol table indicates the named entity is referenced in source code, the code filtering compiler retrieves coordinates from the entry for the named entity in the symbol table. The coordinates identify a location of a definition associated with the named entity in the source code. The definition for the named entity located at the coordinates from the source code is copied into a filtered source listing. The filtered source listing includes a set of definitions from a set of header files associated with named entities that are referenced in the source code. Definitions associated with entities that are unreferenced in the source code are absent from the filtered source listing.

### CROSS-REFERENCE TO RELATED APPLICATIONS

This application claims the benefit of priority of Canadian Patent Application No. 2675692 (Docket No. CA920090017CA1) entitled “Compiler-assisted Program Source Code Filter,” which was filed on Aug. 28, 2009, and is hereby incorporated by reference.

### BACKGROUND

The present invention relates generally to embodiments of an improved data processing system and in particular to a method and apparatus for generating source code files. More particularly, embodiment of the present invention are directed towards providing a computer implemented method, apparatus, and computer usable program code for generating a filtered source code output file using a modified compiler symbol table.

Computer programs are typically written in a high level language, such as, without limitation C and C++. These computer programs may be referred to as source code. Ninety percent (90%) or more of a program's source code may be located in header files. A header file is a text file containing the interface information for a library of functions needed by a compiler. Header files are usually very large, as they declare the full interface of the operating system or library of which they are a component. As a result, header files cause a large volume of code to be included in a program's source code. The code in header files may be written by a user, obtained from standard libraries, obtained from open source libraries, and/or downloaded or licensed from other third party sources. For example, one commonly used standard library header file is, without limitation, the standard input/output header file (stdio.h).

A technique that is frequently used to reduce the compile time associated with standard library headers and other frequently used third party header libraries are precompiled headers (PCH). When a header file is compiled for the first time, the results of compilation are saved and re-used by the compiler each subsequent time the same header file is encountered by the compiler. However, precompiled headers do not assist a user in understanding the voluminous code included in program headers.

### SUMMARY

According to one embodiment of the present invention, a computer implemented method, apparatus, and computer program product for generating a filtered source code listing are provided. A code filtering compiler identifies an entry for a named entity in a symbol table. In response to a flag in the entry for the named entity in the symbol table indicating the named entity is referenced in source code corresponding to the symbol table, the code filtering compiler retrieves coordinates from the entry for the named entity in the symbol table. The coordinates identify a location of a definition associated with the named entity in the source code. The definition for the named entity located at the coordinates from the source code is copied into a filtered source listing. The filtered source listing includes a set of definitions from a set of header files associated with named entities that are referenced in the source code. Definitions associated with entities that are unreferenced in the source code are absent from the filtered source listing.

In another embodiment, a computer implemented method and computer program product for filtering source code are provided. In this embodiment, a named entity in a declaration in source code associated with a computer program is identified. An entry for the named entity is created in a symbol table. The entry includes a flag field. In response to the compiler referencing the entry for the named entity, a flag in the flag field is set to indicate the named entity is referenced in response to the process identifying a reference to the named entity in the source code and referencing the entry for the named entity in the symbol table.

### BRIEF DESCRIPTION OF THE DRAWINGS

FIG. 1 is a pictorial representation of a network of data processing systems in which illustrative embodiments may be implemented;

FIG. 2 is a block diagram of a data processing system in which illustrative embodiments may be implemented;

FIG. 3 is a block diagram of a code filtering compiler in accordance with an illustrative embodiment;

FIG. 4 is a block diagram of a modified symbol table in accordance with an illustrative embodiment;

FIG. 5 is a block diagram of an extended symbol table entry in accordance with an illustrative embodiment;

FIG. 6 is a flowchart of a process for creating a symbol table in accordance with an illustrative embodiment; and

FIG. 7 is a flowchart of a process for generating a filtered source text file in accordance with an illustrative embodiment.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

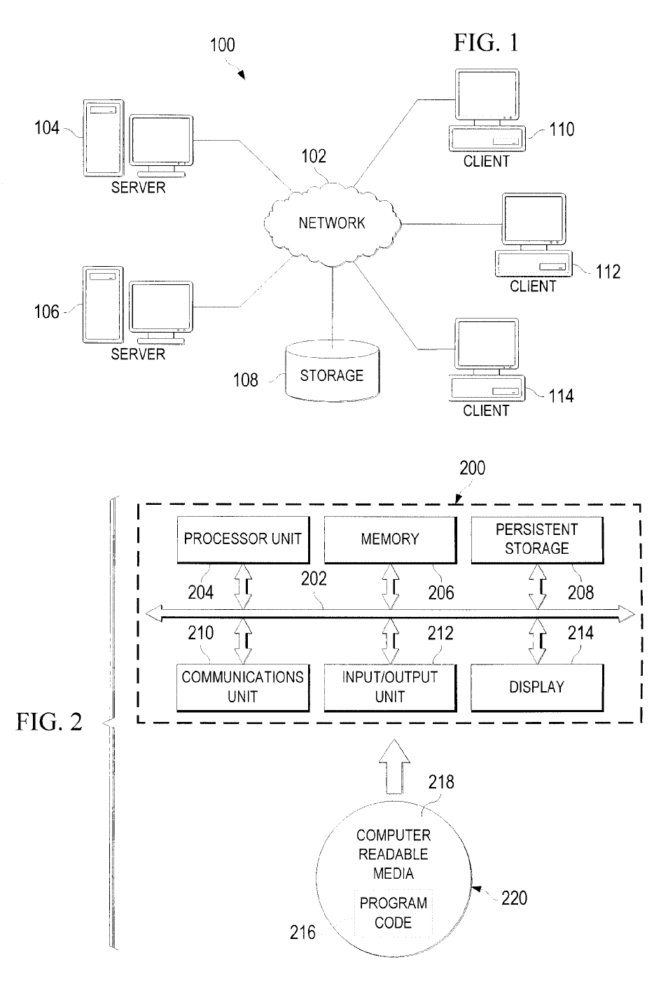

With reference now to the figures and in particular with reference to FIGS. 1-2, examples of diagrams of data processing environments are provided in which illustrative embodiments may be implemented. It should be appreciated that FIGS. 1-2 are only examples and are not intended to assert or imply any limitation with regard to the environments in which different embodiments may be implemented. Many modifications to the depicted environments may be made.

FIG. 1 depicts a pictorial representation of a network data processing system 100 with a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, including thousands of commercial, governmental, educational, and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which illustrative embodiments may be implemented. Data processing system 200 is an example of a computer, such as server 104 or client 110 in FIG. 1, in which computer usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206, in these examples, may be, for example, a random access memory. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as computer usable program code or computer readable program code that may be read and executed by a processor in processor unit 204. The computer readable program code may be embodied on different physical or tangible computer readable media, such as memory 206 or persistent storage 208.

Computer usable program code 216 is located in a functional form on computer readable media 218 and may be loaded onto or transferred to data processing system 200. Computer usable program code 216 and computer readable media 218 include computer program product 220 in these examples. In one example, computer readable media 218 may be, for example, an optical or magnetic disc that is inserted or placed into a drive or other device that is part of persistent storage 208 for transfer onto a storage device, such as a hard drive that is part of persistent storage 208. Computer readable media 218 also may take the form of a persistent storage, such as a hard drive or a flash memory that is connected to data processing system 200.

Alternatively, computer usable program code 216 may be transferred to data processing system 200 from computer readable media 218 through a communications link to communications unit 210 and/or through a connection to input/output unit 212. The communications link and/or the connection may be physical or wireless in the illustrative examples. The computer readable media also may take the form of non-tangible media, such as communications links or wireless transmissions containing the computer readable program code.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown.

For example, a bus system may be used to implement communications fabric 202 and may include one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

Generally, the majority of the source code in a computer program is code located in header files. The header files are sometimes very large because they declare the full interface of the operating system or library of which they are a component. However, the application programmer rarely uses more than a small fraction of each of the interfaces found in the header files. For example, a program may include the standard input/output header and all the associated interfaces, even if the programmer only uses the print function (printf). The illustrative embodiments recognize that header files frequently cause a large volume of unused source code to be included in an application program. The embodiments further recognize that this large volume of unused source code may result in a user having greater difficulty in understanding the code, analyzing the code, and/or debugging the code.

Thus, according to one embodiment described herein, a computer implemented method, apparatus, and computer program product for generating a filtered source code listing are provided. A code filtering compiler identifies an entry for a named entity in a symbol table. In response to a flag in the entry for the named entity in the symbol table indicating the named entity is referenced in source code corresponding to the symbol table, the code filtering compiler retrieves coordinates from the entry for the named entity in the symbol table. The coordinates identify a location of a definition associated with the named entity in the source code. The definition for the named entity located at the coordinates from the source code is copied into a filtered source listing. The filtered source listing includes a set of definitions from a set of header files associated with named entities that are referenced in the source code. Definitions associated with entities that are unreferenced in the source code are absent from the filtered source listing.

In another embodiment, a computer implemented method and computer program product for filtering source code are provided. In this embodiment, a named entity in a declaration in source code associated with a computer program is identified. An entry for the named entity is created in a symbol table. The entry includes a flag field. In response to a determination that the entry for the named entity is referenced in the source code, the flag in the flag field is set to indicate that the named entity is referenced in the source code. The entry for the named entity is referenced where the code filtering compiler encounters a reference to the named entity in the source code and references the entry for the named entity in the symbol table.

The filtered source listing may be used to perform at least one of compiling the filtered source listing to reduce compile time, debugging the filtered source listing to reduce the amount of code to be debugged and eliminate irrelevant code from the debugging process, improve understanding of the program source code by eliminating irrelevant code, and providing improved customer support by focusing customer support efforts on the filtered source listing rather than attempting to analyze all of the code in the original source file.

As used herein, the term “at least one of”, when used with a list of items means that different combinations of one or more of the items may be used, and only one of each item in the list may be needed. For example, “at least one of item A, item B, and item C” may include, for example, without limitation, item A or item A and item B. This example also may include item A, item B, and item C or item B and item C.

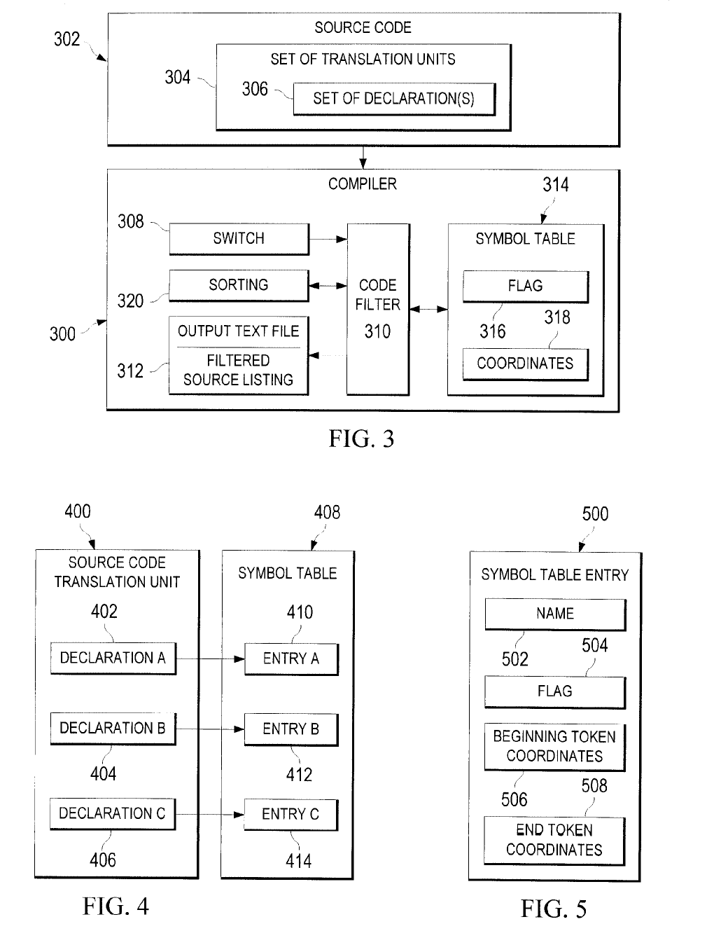

Referring now to FIG. 3, a block diagram of a code filtering compiler is shown in accordance with an illustrative embodiment. Compiler 300 is a software component that filters source code 302 to generate a filtered output text file. Compiler 300 is implemented using any type of compiler, assembler, language translator, source-to-source translator, or language converter. For example, but without limitation, compiler 300 may be implemented as a source-to-source compiler, a just-in-time (JIT) compiler, or a stage compiler.

Source code 302 is a computer program, which may be written in a high level language, such as, but without limitation, C, C++, Java, JavaScript, Fortran, Cobol, or any other known or available programming language. Source code 302 may also be referred to as a source listing or source file. Users of programming languages, such as, but without limitation, C and C++, frequently segment their program source code into one or more translation units. In this example, source code 302 includes a set of translation units 304. A translation unit in set of translation units 304 is a segment of code in source code 302 that includes a set of header files. A translation unit may also optionally include only a set of include files or include a set of include files in addition to the set of header files. As used herein, the term set refers to one or more. Thus, the set of header files may include a single header file, as well as two or more header files. Likewise, set of translation units 304 may include one or more translation units. A single translation unit may include only a portion of source code 302 or include all the code in source code 302. In other words, set of translation units 304 may include only a single translation unit that includes all of source code 302, two translation units, as well as three or more translation units that include portions of source code 302.

Set of translation units 304 includes set of declarations 306. Set of declarations 306 may include a single declaration, as well as two or more declarations. A declaration may be a code segment that instructs the compiler as to which memory cells are needed for a particular function call associated with a named entity. In one example, a declaration may include an identification of an entity name, a return type, and an argument list for the named entity. As used herein, a declaration in set of translation units 304 may also optionally include in-line functions in the headers. An in-line function is a function that is defined in the header file.

Set of declarations 306 is a set of one or more declarations in set of translation units 304 of source code 302, which is sent to compiler 300. Compiler 300 includes switch 308. Switch 308 is software component that receives a user selection to filter source code 302. In response to receiving the user's selection to filter source code 302, switch 308 activates code filter 310 to generate a text file containing filtered source listing 312.

Code filter 310 selects a translation unit from set of translation units 304 and filters out declarations from header files that are not needed by the computer program from the selected translation unit. The unused declarations that are filtered from the selected translation unit will not appear in resulting filtered source listing 312. Code filter 310 iteratively selects each translation unit in set of translation units 304 and only copies the declaration for referenced named entities into filtered source listing 312. The unused declarations are not copied into the filtered source listing 312. In this manner, the declaration associated with unreferenced named entities are removed from the original source code 302 until all the translation units in set of translation units 304 have been filtered to eliminate unnecessary source code. In this manner, code filter 310 generates filtered source listing 312 in an output text file that is a minimal textual representation of source code 302.

In this example, code filter 310 in compiler 300 processes each translation unit in set of translation units 304. While compiler 300 processes a given translation unit, compiler 300 generates symbol table 314 for the translation unit. Symbol table 314 is a data structure that includes an entry for each identifier in source code 302. Symbol table 314 may also be referred to as a compiler dictionary. When compiler 300 encounters a named entity in source code 302, compiler 300 looks up the named entity in symbol table 314 to obtain information associated with the named entity. If the named entity is not found in symbol table 314, compiler 300 creates an entry in symbol table for the named entity. The entry in symbol table 314 for the named entity contains information relating to the entity, such as, without limitation, the entity's name, the entity type, and the location of the entity declared. For example, if the named entity is a function, the entry may include, without limitation, the function name, the return type, and the argument list for the function. In this embodiment, code filter 310 may also add additional information associated with the entity.

In this embodiment, symbol table 314 includes flag 316 in addition to other information for the named entity. Flag 316 is a field in the entry for the named entity that indicates whether the entry is used, either directly or transitively, in source code 302. In other words, when a named entity is identified in source code 302, compiler 300 looks up the entry in symbol table 314 that corresponds to the entity. If an entry is found in symbol table 314, compiler 300 sets flag 316 corresponding to the entity to indicate that the entity has been looked up in symbol table 314. In one embodiment, flag 316 is a bit in a flag field that is set to indicate the named entity was referenced in the symbol table.

Thus, when compiler 300 looks up an entry in symbol table 314 in the context of an entity in source code 302, compiler 300 identifies the entry as one that is used or found in source code 302. Compiler 300 sets flag 316 corresponding to the item that has been looked up. If flag 316 is set, it indicates that the named entity in a declaration or definition has been looked up in symbol table 314.

An entry in symbol table 314 may also contains coordinates 318. Coordinates 318 are the source file coordinates of the beginning token and end token of a declaration that corresponds to the given entry. Code filter 310 uses coordinates 318 to locate declarations in source code 302 associated with named entities that have been looked up or otherwise referenced in symbol table 314.

In this embodiment, after processing a translation unit, code filter 310 identifies every named entity in symbol table 314 that has been looked up or referenced by checking the flag for each named entity. For every named entity in symbol table 314 with the flag set to indicate that the entity has indeed been referenced in the symbol table, code filter 310 uses coordinates 318 to locate the relevant portion of code in source code 302 that contains the declaration or definition for the entity and copies that relevant portion of the code into filtered source list 312. The declarations and definitions in the header files for entities that have not been referenced in symbol table 314 and, therefore, are not used by the program, are not copied from source code 302 into filtered source list 312. Thus, symbol table 314 is an extended or improved symbol table that provides flag 316 and coordinates 318 for utilization by code filter 310 in creating filtered source listing 312.

Sorting 320 is a software component that sorts symbol table 314 so that the order of entries is equivalent to the order in which the corresponding declarations appear in the preprocessed translation unit. Sorting 320 may be implemented using any known or available software for sorting declarations in an output text file. Sorting 320 may be used in some cases where the order in which definitions are output in filtered source listing 312 is important to execution of the program. For example, in some high level languages, the definition of a type should be presented in the source code before presenting the definition of the function that uses that type as its return type.

Sorting 320 optionally sorts the definitions in the output text file to ensure that the definitions are in the correct order, such as, without limitation, sorting the definition of a type in the source file before the definition of the function that uses that type definition. Thus, sorting 320 sorts definitions based on the order of appearance of the definitions in the source file.

Compiler 300 then produces filtered source listing 312 in an output text file by visiting in order of each entry in symbol table 314 and streaming all of the indicated tokens identified in coordinates 318 to the desired output text file in the order dictated by sorting 320. In another embodiment, sorting 320 is not used. In this example, definitions are copied to the output text file to generate filtered source listing 312 in alphabetical order of the entries in the symbol table.

Thus, filtered source listing 312 is a filtered version of the original source code 302 written in the same programming language as source code 302. However, some or all of the unused code in the header files that is found in the original source code 302 is removed from filtered source listing 312. In other words, source code 302 contains all the declarations that are used by the program, as well as declarations and/or definitions in the header files that are not used or needed by the program. Filtered source listing 312 contains all the declarations that are used by the program, but one or more of the declarations and/or definitions that are not used by the program have been removed. In this example, but without limitation, all of the unused declarations and definitions have been removed from filtered source listing 312.

FIG. 4 is a block diagram of a modified symbol table in accordance with an illustrative embodiment. Source code translation unit 400 is a translation unit in a set of translation units in program source code, such as set of translation units 304 in FIG. 3. Source code translation unit 400 may be a portion of the source code in a computer program or it may include all of the source code in the computer program. Source code translation unit 400 may include any number of declarations. In this example, but without limitation, source code translation unit 400 includes declaration A 402, declaration B 404, and declaration C 406. However, a translation unit may include only a single declaration, two declarations, four declarations, or any other number of declarations.

Symbol table 408 is a modified compiler dictionary, such as symbol table 314 in FIG. 3. Symbol table 408 includes an entry corresponding to each declaration in source code translation unit 400. In this example, a compiler with a code filter processes source code translation unit 400 to identify declarations. Each time the code filter identifies a declaration, such as declaration A 402, the code filter generates a corresponding entry in symbol table 408. In this example, entry A 410 corresponds to declaration A 402, entry B 412 corresponds to declaration B 404, and entry C 414 corresponds to declaration C 406. Each entry in symbol table comprises information associated with the corresponding declaration, such as, but without limitation, an entity name, return type, argument, a flag, and/or coordinates of the location of the declaration in the source code.

FIG. 5 is a block diagram of an extended symbol table entry in accordance with an illustrative embodiment. Symbol table entry 500 is an extended entry in a compiler symbol table, such as entry A 410 in symbol table 408 in FIG. 4 or symbol table 314 in FIG. 3. Name 502 is an identifier of a named entity in a program's source code. An entity may be, for example and without limitation, a variable, a function, a type, a template, or a namespace. Flag 504 is a flag that indicates whether the named entity has been referenced by the compiler. When the compiler references a named entity for the first time, it sets flag 504 associated with that named entity to indicate that the entry for the named entity has been referenced in the symbol table. In other words, flag 504 indicates whether the compiler has looked up the named entity in the symbol table. Beginning token coordinates 506 is the location of a beginning of a declaration that includes the named entity in the source code. End token coordinates 508 is a location of the end of the declaration that includes the named entity in the source code. Coordinates 506 and 508 may be implemented using any type of coordinates or location identification. In this example, beginning token coordinates 506 is a number of characters from the start of the source code file at which the beginning of the declaration is located in the original source code file. Beginning token coordinates 506 may also be, without limitation, a number of lines from the start of the source code file and a number of characters from the start of a given line at which the beginning of the declaration is located in the original source code file. End token coordinates 508 may be implemented as an identification of the number of characters from the start of the source code file at which the end of the declaration is located in the original source code file. End token coordinates 508 may also identify a number of lines from the start of the source code file and a number of characters from the start of a given line at which the end of the declaration is located in the original source code file.

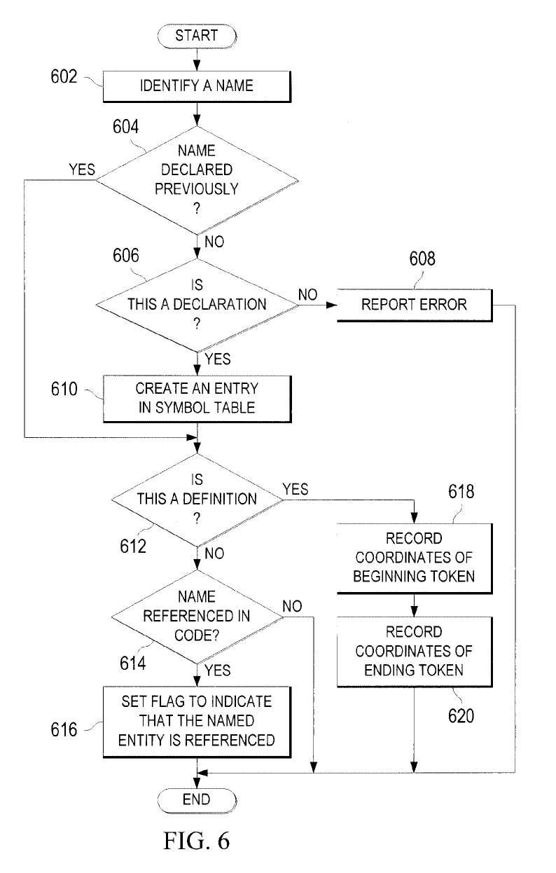

FIG. 6 is a flowchart of a process for creating a symbol table in accordance with an illustrative embodiment. The process in FIG. 6 may be implemented by software for filtering source code, such as, but without limitation, code filter 310 in FIG. 3.

The process begins by identifying 602 a name associated with an entity in source code. A determination is made 604 as to whether the name was previously declared. If the name was not previously declared, the process makes a determination 606 as to whether this is a declaration. In other words, the process determines if the identified name is found in a declaration. If this is not a declaration, an error is reported 608 with the process terminating thereafter.

Otherwise, if this is a declaration, an entry is created 610 in the compiler's symbol table for the name. In other words, each time an entity is declared for the first time in source code, the compiler creates an entry for the entity in the symbol table. After creating the entry, or if the name is declared previously, the process makes a determination 612 as to whether this is a definition. If this portion of the source code is not a definition, the process makes a determination 614 as to whether the name is referenced in the code. If no, the process terminates thereafter. If the name is referenced in the code in any way, the flag associated with the entry in the symbol table is set to indicate that the named entity is referenced 616 with the process terminating thereafter.

In response to a determination that this portion of the source code is a definition, coordinates of a beginning token for the definition are recorded 618 in the entry in the symbol table. Coordinates for an ending token for the definition are also recorded 620 in the entry in the symbol table with the process terminating thereafter.

In another embodiment, instead of reporting an error in response to determining 608 that the identified name is not a declaration, the process creates 610 an entry for the named entity in the symbol table and continues executing until the process terminates.

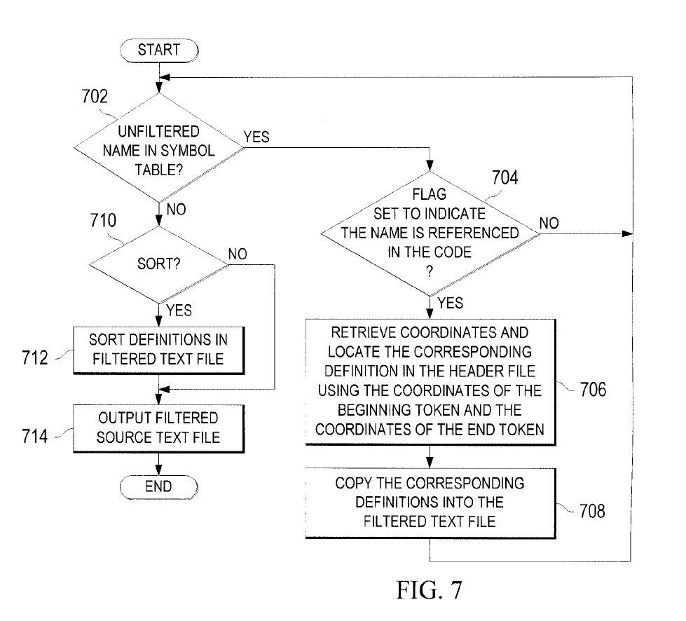

FIG. 7 is a flowchart of a process for generating a filtered source text file in accordance with an illustrative embodiment. The process in FIG. 7 may be implemented by software for filtering source code, such as, but without limitation, code filter 310 in FIG. 3. The process in FIG. 7 may be implemented by software for sorting definitions, such as, but not limited to, sorting 320 in FIG. 3.

The process begins by making a determination 702 as to whether an unfiltered name is in a compiler's symbol table. An unfiltered name is a named entity in the source code that has not yet been processed by the code filter. If an unfiltered name is found in the symbol table, the process makes a determination 704 as to whether a flag associated with the name is set in the symbol table to indicate the name is referenced in the source code. If no, the process returns to determine 702 whether a subsequent unfiltered name is in the compiler's symbol table. If a flag in the symbol table is set indicating the name is referenced in the source code, the process retrieves 706 coordinates of the beginning token and the end token of a definition corresponding to the name in the header file in the source code and locates the definition corresponding to the name in the header file in the source code using the coordinates of the beginning token and the coordinates of the end token. In this example, the beginning and ending token coordinates are found in the symbol table entry for the unfiltered name. The corresponding definition is copied 708 into the filtered text file. The process then returns to determine 702 whether a subsequent unfiltered name is in the compiler's symbol table. This process continues iteratively until all the named entities in the symbol table have been processed by the code filter.

When no unfiltered names are found in the symbol table, a determination is made 710 as to whether to sort the filtered text file. If yes, the definitions in the filtered text file are sorted 712. After sorting, or if no sorting is required, the filtered source text file is output 714 with the process terminating thereafter.

Thus, embodiments described herein provide a technique to filter a computer source code so that unused code, such as unnecessary declarations found in header files, are eliminated. In other words, embodiments described herein generate a minimal programming code listing in a textual format. Filtering source code reduces the amount of code in a high-level language program, which may be used to assist a user in understanding program code, debug code by eliminating irrelevant code segments, and provide improved customer support. Filtering source code may also be used during compilation to reduce compile time. The filtered code improves debugging and customer support by eliminating irrelevant information from the source code so that a user is only dealing with the code that may be causing the bug or other problems with program. The filtered code listing may also be used in test-case generation for service and support generation, program code analysis, program understanding, and shortened compilation time.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

An embodiment of a data processing system suitable for storing and/or executing program code includes at least one processor coupled directly or indirectly to memory elements through a system bus, such as a communications fabric. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer program product for filtering source code, the computer program product comprising:
a computer usable storage medium having computer usable program code embodied therewith, the computer usable program code comprising:
computer usable program code configured to identify an entry for a named entity in a symbol table;
computer usable program code configured to retrieve coordinates from the entry for the named entity in the symbol table in response to a flag in the entry for the named entity in the symbol table indicating the named entity is referenced in the source code corresponding to the symbol table, wherein the coordinates identify a location of a definition associated with the named entity in the source code; and
computer usable program code configured to copy the definition located at the coordinates from the source code into a filtered source listing, wherein the filtered source listing comprises a set of definitions from a set of header files associated with named entities that are referenced in the source code, and wherein definitions associated with entities that are unreferenced in the source code are absent from the filtered source listing.

2. The computer program product of claim 1 further comprising:
computer usable program code configured to filter the definitions associated with the named entity that is unreferenced from the source code to generate the filtered source listing in response to the flag in the entry for the named entity in the symbol table indicating the named entity is unreferenced in the source code corresponding to the symbol table, wherein any definitions from the set of header files for the named entity that are unreferenced are absent from the filtered source listing.

3. The computer program product of claim 2 further comprising:
computer usable program code configured to sort the set of definitions in the filtered source listing to form a sorted filtered source listing in response to receiving a selection to sort the set of definitions in the filtered source listing.

4. The computer program product of claim 3 further comprising:
computer usable program code configured to output the sorted filtered source listing.

5. The computer program product of claim 1, wherein the coordinates comprise first coordinates of a beginning token for the location of the definition and second coordinates of an ending token for the location of the definition.

6. The computer program product of claim 1 further comprising:
computer usable program code configured to perform a debug process on the filtered source listing.

7. A computer program product for filtering source code, the computer program product comprising:
a computer usable storage medium having computer usable program code embodied therewith, the computer usable program code comprising:
computer usable program code configured to identifying a named entity in a declaration in the source code associated with a computer program, by a code filtering compiler;
computer usable program code configured to creating an entry for the named entity in a symbol table, wherein the entry comprises a flag field; and
computer usable program code configured to set a flag in the flag field to indicate the named entity is referenced in the source code in response to the compiler identifying a reference to the named entity in the source code and referencing the entry for the named entity in the symbol table.

8. The computer program product of claim 7 further comprising:
computer usable program code configured to record coordinates for a definition in the source code in a coordinates field of the entry for the named entity in the symbol table in response to the code filtering compiler identifying the definition associated with the named entity in the source code.

9. The computer program product of claim 7, wherein the coordinates comprise coordinates of a beginning token for the location of the definition and coordinates of an ending token for the location of the definition.

10. The computer program product of claim 7 further comprising:
computer usable program code configured to identify a set of entries for a set of referenced named entities in the symbol table, wherein each entry in the set of entries for the set of referenced named entities contains a flag in the flag field indicating that each named entity corresponding to the each entry in the set of entries is referenced in the source code;
computer usable program code configured to retrieve a set of coordinates from the set of entries for the set of referenced named entities, wherein the set of coordinates identify locations of a set if definitions associated with the set of referenced named entities in the source code; and
computer usable program code configured to copy the set of definitions located at the set of coordinates from the source code into a filtered source listing, wherein the filtered source listing comprises definitions from a set of header files associated with named entities that are referenced in the source code, and wherein definitions associated with entities that are unreferenced in the source code are absent from the filtered source listing.

11. A code filtering compiler in a date processing system comprising:
a bus system;
a communications system coupled to the bus system;
a memory connected to the bus system, wherein the memory includes computer usable program code; and
a processing unit coupled to the bus system, wherein the processing unit executes the computer usable program code to:
identify an entry for a named entity in a symbol table;
identify a flag in the entry for the named entity in the symbol table indicating the named entity is referenced in source code corresponding to the symbol table;
retrieve coordinates from the entry for the named entity in the symbol table, wherein the coordinates identify a location of a definition associated with the named entity in the source code; and
copy the definition located at the coordinates from the source code into a filtered source listing, wherein the filtered source listing comprises a set of definitions from a set of header files associated with named entities that are referenced in the source code, and wherein definitions associated with entities that are unreferenced in the source code are absent from the filtered source listing.

12. The code filtering compiler of claim 11, wherein the processing unit further executes the computer usable program code to filter the definitions associated with the named entity that is unreferenced from the source code to generate the filtered source listing in response to a flag in the entry for the named entity in the symbol table indicating the named entity is unreferenced in the source code corresponding to the symbol table, wherein the filtered source listing does not contain any definitions from the set of header files for the named entity that are unreferenced.

13. The code filtering compiler of claim 11, wherein the processing unit further executes the computer usable program code to receive a selection to sort the set of definitions in the filtered source listing and sort the set of definitions in the filtered source listing to form a sorted filtered source listing.

14. The code filtering compiler of claim 11, wherein the processing unit further executes the computer usable program code to output the sorted filtered source listing.

15. The code filtering compiler of claim 11, wherein the coordinates comprise first coordinates of a beginning token for the location of the definition and second coordinates of an ending token for the location of the definition.

16. A computer implemented method of filtering source code, the computer implemented method comprising:
identifying an entry for a named entity in a symbol table;
responsive to a flag in the entry for the named entity in the symbol table indicating the named entity is referenced in the source code corresponding to the symbol table, retrieving coordinates from the entry for the named entity in the symbol table, wherein the coordinates identify a location of a definition associated with the named entity in the source code; and
copying the definition located at the coordinates from the source code into a filtered source listing, wherein the filtered source listing comprises a set of definitions from a set of header files associated with named entities that are referenced in the source code, and wherein definitions associated with entities that are unreferenced in the source code are absent from the filtered source listing.

17. The computer implemented method of claim 16 further comprising:
responsive to the flag in the entry for the named entity in the symbol table indicating the named entity is unreferenced in the source code corresponding to the symbol table, filtering the definitions associated with the named entity that is unreferenced from the source code to generate the filtered source listing, wherein any definitions from the set of header files for the named entity that are unreferenced are absent from the filtered source listing.

18. The computer implemented method of claim 17 further comprising:
responsive to receiving a selection to sort the set of definitions in the filtered source listing, sorting the set of definitions in the filtered source listing to form a sorted filtered source listing; and
outputting the sorted filtered source listing.

19. The computer implemented method of claim 16, wherein the coordinates comprise first coordinates of a beginning token for the location of the definition and second coordinates of an ending token for the location of the definition.

20. The computer implemented method of claim 16 further comprising:
performing a debug process on the filtered source listing.
